(19) United States
(12) Patent Application Publication
(10) Pub. No.: US 2007/0187164 A1
(43) Pub. Date: Aug. 16, 2007

(54) Wheel exchangeable scooter

(75) Inventors: Kyung-Suk Yang, Daegu (KR); In-suk Back, Chungcheongnam-do (KR)

Correspondence Address: CANTOR COLBURN, LLP, 55 GRIFFIN ROAD SOUTH, BLOOMFIELD, CT, 06002, US

(73) Assignee: YANG, KYUNG-SUK, SUSEONG-GU, DAEGU, KOREA, REPUBLIC OF (KR)

(21) Appl. No.: 10/591,967

(22) PCT Filed: Mar. 8, 2005
(86) PCT No.: PCT/KR05/00638

§ 371 Date: Sep. 7, 2006

(30) Foreign Application Priority Data
Mar. 8, 2004 (KR) 10-2004-0015556

(51) Int. Cl. B62D 61/12

(52) U.S. Cl. 180/209

(57) ABSTRACT

A scooter with variable wheel configuration capable of being configured from a two-wheeled vehicle to a three-wheeled vehicle and vice-versa, according to requirement, is provided. The scooter includes: a frame for supporting and carrying a rider or a passenger and containing a battery and a controller; a steering assembly mounted on the front of the frame to pivot in left and right directions for steering, the steering assembly having a lower portion to which a front wheel is rotatably mounted and an upper portion provided with a handgrip for a rider to steer, a brake lever, an actuator control lever, and a throttle grip; a mount formed at a rear end of the frame in one-piece, the mount having a first mounting portion on one end and a second mounting portion on the other end; a first driving unit detachably mounted on the first mounting portion of the mount for a two-wheeled configuration or on the second mounting portion of the mount for a three-wheeled configuration; and a second driving unit detachably mounted to the first mounting portion and connected to the first driving unit for the three-wheeled configuration.

### TECHNICAL FIELD

The present invention relates to a wheel exchangeable scooter, and more specifically, to a scooter capable of allowing a user or rider to selectively configure the scooter as a two or three-wheeled vehicle, and adjust the power output according to the number of wheels mounted.

### BACKGROUND ART

Generally, scooters, classified as small motorized vehicles or mini motorcycles, are easy to walk and park, while providing a superb fuel efficiency and a comfortable ride. Their applications for use are broad, and include leisure, sport, and means for transportation within a nearby vicinity. As shown in FIG. 1, the basic structure of a two-wheeled scooter includes a frame 1, a front wheel 2 attached so that it can spin at the front end of the frame 1, a rear wheel 3 attached so that it can spin at the rear end of the frame 1, a steering assembly 4 capable of pivoting the front wheel 2 in a left and right direction, a handlebar 5 at the upper portion of the steering assembly 4 to control the steering assembly 4, a brake lever 6 on each end of the handlebar 5, a throttle lever 7 on one end of the handlebar 5, an engine 8 mounted on the frame 1 to drive the rear wheel 3, and a seat 9 attached to the frame 1. This type of two-wheeled scooter can be ridden by adults and physically able persons at relatively high speeds. In one aspect, the three-wheeled scooter in FIG. 2 has the same characteristics of the scooter in FIG. 1, with the exception of having two rear wheels 3. This type of three-wheeled scooter is suitable to be ridden at slower speeds and under safer conditions by children, women, and persons with physical disabilities.

However, these types of the related art scooters are manufactured with either two or three fixed wheels, which give rise to a number of problems. First, because each scooter has either two or three fixed wheels, its user applications are limited.

Also, with scooters of the related art manufactured recently, power can be lost between their motors or engines and driving wheels, mounting and removal of wheels can be slow and cumbersome, and there is no reverse gear.

### DISCLOSURE OF INVENTION

Technical Problem

To solve the above problems, the present invention provides a scooter with variable wheel configuration that allows a rider or user to readily switch between a two and three-wheeled configuration of the scooter.

Another object of the present invention is to provide a scooter with variable wheel configuration that allows easy removal and installation of wheels, when switching between a two and three-wheeled configuration of the scooter.

A further object of the present invention is to provide a scooter with variable wheel configuration that allows the selective use of driving units in accordance with the number of wheels employed by the scooter, thereby improving efficiency.

A still further important object of the present invention is to provide a scooter with variable wheel configuration that has a simple structure, and prevents power train loss, enabling optimal conveyance of power to the driving wheels.

An additional object of the present invention is to provide a scooter with variable wheel configuration that allows quick and easy mounting and removal of the wheels of the scooter.

A further additional object of the present invention is to provide a scooter with variable wheel configuration, having a reverse capability.

Technical Solution

According to an aspect of the present invention, there is provided a scooter with variable wheel configuration between a two-wheeled vehicle and a three-wheeled vehicle, the scooter including: a frame for supporting and carrying a rider or a passenger and containing a battery and a controller; a steering assembly mounted on the front of the frame to pivot in left and right directions for steering, the steering assembly having a lower portion to which a front wheel is rotatably mounted and an upper portion provided with a handgrip for a rider to steer, a brake lever, an actuator control lever, and a throttle grip; a mount formed at a rear end of the frame in one-piece, the mount having a first mounting portion on one end and a second mounting portion on the other end; a first driving unit detachably mounted on the first mounting portion of the mount for a two-wheeled configuration or on the second mounting portion of the mount for a three-wheeled configuration; and a second driving unit detachably mounted to the first mounting portion and connected to the first driving unit for the three-wheeled configuration.

### BRIEF DESCRIPTION OF THE DRAWINGS

The spirit of the present invention can be understood more fully with reference to the accompanying drawings. In the drawings:

FIG. 1 is a perspective view of a conventional two-wheeled scooter;

FIG. 2 is a perspective view of a conventional three-wheeled scooter;

FIG. 3 is a perspective view of a two-wheeled configuration of a scooter according to the present invention;

FIG. 4 is a perspective view of a driving unit of the two-wheeled scooter configuration of FIG. 3;

FIG. 5 is a perspective view of a three-wheeled configuration of a scooter according to the present invention;

FIG. 6 is a perspective view of a driving unit of the three-wheeled configuration of FIG. 5; and

FIG. 7 is a perspective view of a wheel with a built-in motor.

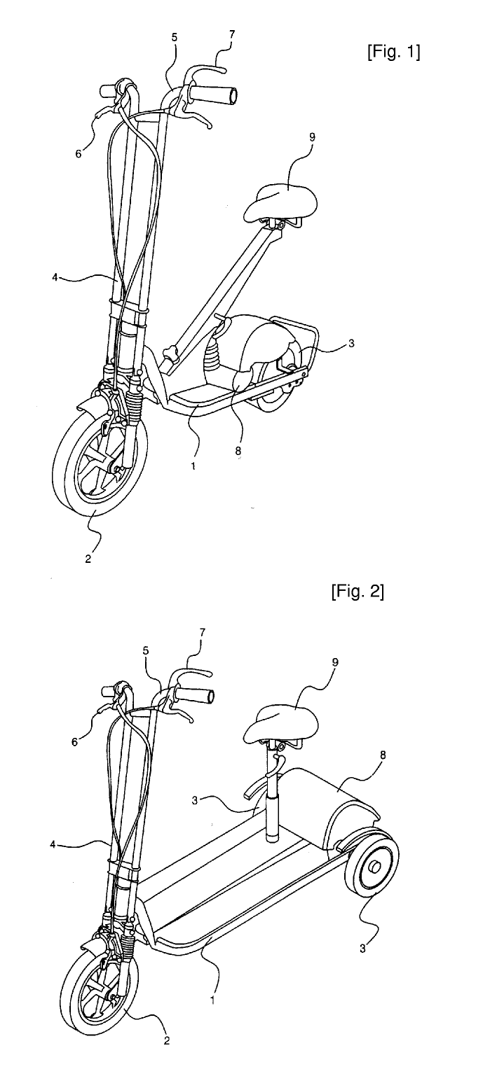

### BEST MODE FOR CARRYING OUT THE INVENTION

Hereinafter, preferred embodiments of a scooter with variable wheel configuration according to the present invention will be described in detail with reference to the accompanying drawings.

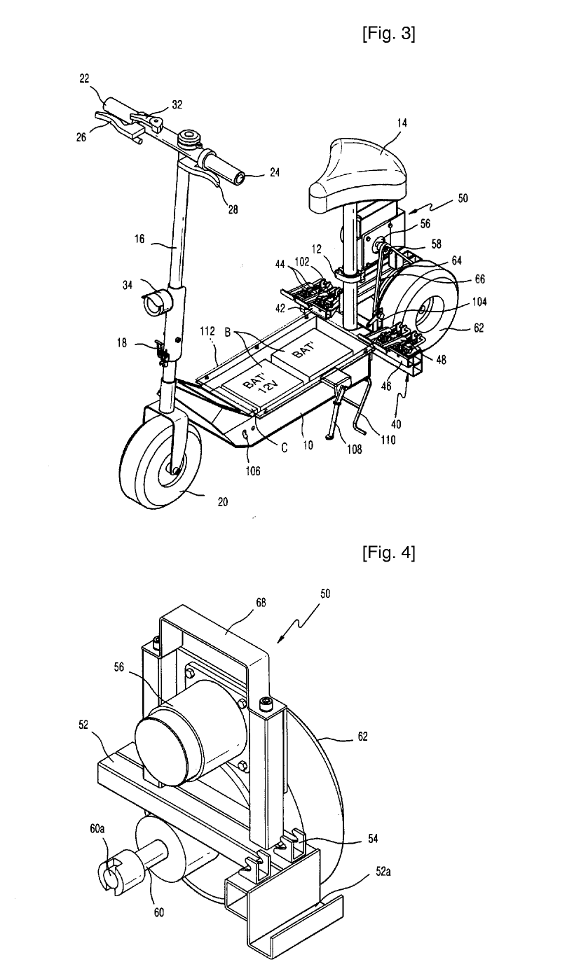

First, referring to FIGS. 3 and 4, a scooter with variable wheel configuration of the present invention includes a chassis with a frame 10 that can support a driver and a passenger during transportation. The frame 10 should have a compartment for storing rechargeable batteries (B) and a controller (C). Fixed at the rear end of the frame 10 is a telescopic seat post having a seat clamp 12 that allows the height of a seat 14, fixed at the top of the seat post, to be adjusted.

Attached to the front end of the frame 10 is a steering assembly 16 that can pivot in a left and right direction. The steering assembly 16 may be height-adjustable by means of a clamp 18 and foldable. At the lower end of the steering assembly 16 is a front wheel 20 mounted so that it can spin. Formed at the top of the steering assembly 16 are handgrips 22 and 24 that can be gripped by a rider, the handgrips 22 and 24 respectively having brake levers 26 and 28 that can be actuated by the driver's hands. Also, located at one of the handgrips 24 is an actuator control lever 32 to control an actuator for a driving unit, which will be described later. Of course, a headlight 34 for providing illumination under dark driving conditions can be installed at an appropriate height on the steering assembly 16.

Installed transversely at the rear end of the frame 10 of the scooter with variable wheel configuration according to the present invention is a mount 40 that allows a driving unit (to be described later) to be detachably mounted thereon. The mount 40 is a hollow tube having a circular or square cross-section.

On one end of the mount 40 is a first mounting portion 42 for accommodating the detachable mounting of a first and a second driving unit (to be described later). There is fastener 44 on the first mount 42 for detachably fastening a driving unit thereto. There may be two or more fasteners for this purpose. The fastener 44 facilitates the installation and removal of a driving unit, and it may be a clamp to firmly hold the driving unit in place.

In addition, on the other end of the mount 40 is a second mounting portion 46 for accommodating the mounting of a two-wheeled driving unit in a three-wheeled configuration. As in the first mounting portion 42, the second mounting portion 46 also has a fastener 48 to detachably mount a driving unit thereon. There may be two or more fasteners for this purpose. The fastener 48 facilitates the installation and removal of a driving unit, and it may be a clamp to firmly hold the driving unit in place.

A first driving unit 50 for a two-wheeled scooter configuration is detachably mounted to a suitable portion of the mount 40, so that it can be mounted and removed at will. The first driving unit 50 has a base 52 for mounting the unit on the mount 40. At the front end of the base 52 there may be a bent mounting portion 52a, formed to encase the bottom portion of the mount 40. Above the bent mounting portion 52a is a notched portion 54 for receiving the fastener 44 or 48 that secures the driving unit 50 to the mount 40, the fasteners 44 and 48 being installed at the mounting portion 42 and 46. Installed at the base 52 to provide motive force is an actuator 56 connected to a battery (B) and a controller (C). The actuator 56 should be a reversible motor, capable of bi-directional rotation. A sprocket 58 for transferring driving force stems from the actuator 56. Also, an axle 60 is rotatably fixed to the lower portion of the base 52. Attached to one end of the axle 60 is a wheel 62, and fixed at the other end is a coupling 60a that enables a second driving unit (to be described later) to be detachably mounted. A sprocket 64 is formed at the inner portion of the wheel 62. The sprocket 58 of the actuator 56 is connected by a belt or chain 66 to the sprocket 64 of the wheel 62. In this configuration, the power from the actuator 56 can be directly transferred to the wheel 62. If desired, a handle 68 can be formed on the first driving unit 50 to facilitate the transportation and use of the unit.

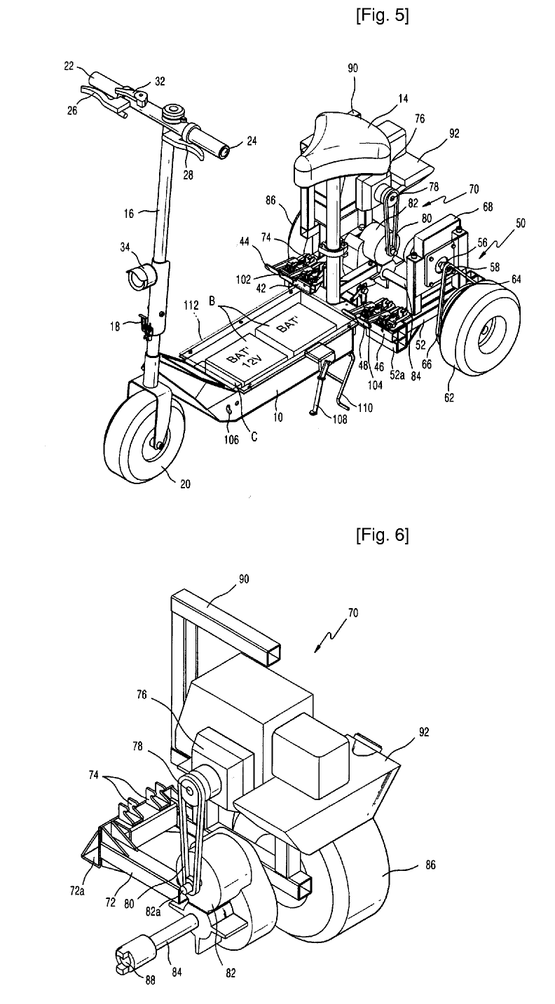

Referring to FIGS. 5 and 6, a second driving unit 70 is detachably installed on the second mounting portion 54 of the mount 40. The second driving unit 70 has a base 72 that allows it to be mounted to and removed from the mount 40. At the front end of the base 72 is a bent mounting portion 72a, formed to encase the bottom portion of the mount 40. Above the bent mounting portion 72a is a notched portion 74 for receiving the fastener 44 or 48 that secures the driving unit 70 to the mount 40, the fastener 44 and 48 being installed at the mounting portion 42 and 46. Installed at the base 72 to provide motive force is an actuator 76. The actuator 76 should be an engine using diesel, gasoline, or similar fuel. A sprocket 78 for transmitting the driving force from the actuator 76 stems from the actuator 76. The sprocket 78 is connected via a chain 80 or a belt to a sprocket 82a of a transmission 82. In order to transmit driving force and provide acceleration and deceleration, the transmission 82 may have a main gear, a differential gear, and a driven gear which are made up of pinion, ring, and side gears. A drive shaft 84 is rotatably fixed to the transmission 82; and a wheel 86 is attached to one end of the drive shaft 84, while a coupling 88, enabling the connection of the short end of the drive shaft 60 of the first driving unit 50 described previously, is attached to the other end. If required, a handle 90 can be attached to the second driving unit 70 to facilitate its transportation and use. Of course, a fuel cell 92 is connected to the actuator 76 of the second driving unit 70 to supply the actuator 76 with fuel. A throttle grip 30 is connected via a wire (not shown) to the throttle wire connector 102 on the mount 40. The throttle wire connector 102 may be a hook connector that can easily and quickly connect to and disconnect from each actuator 56 and 76. Also, a brake lever 28 is connected by a wire (not shown) to a brake wire connector 104 on the mount 40 that actuates a brake assembly on each wheel 62 and 86. In addition, a control button 106, of a controller (C) located inside the frame for switching the rotational direction of the actuator 56, is located on the side of the frame 10. Although not shown as such in this embodiment, the control button 106 can be located on the handlebars. Furthermore, in order to securely park or stow the scooter, a kickstand 108 or 110 can be mounted on an appropriate portion of the frame of the scooter.

As illustrated with a dotted line in FIGS. 3 and 5, a cover 112 covering the inside of the frame 10 where the batteries and controller are stored, protects not only the batteries and controller from outside elements, but also the passenger.

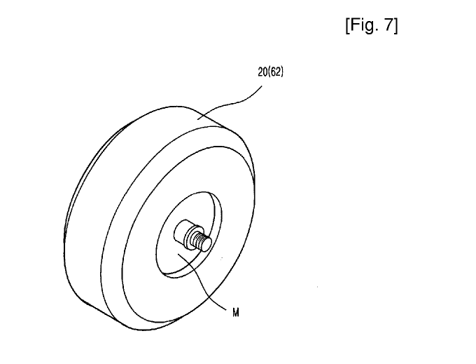

According to another embodiment of the present invention, as shown in FIG. 7, a front wheel 20 may include a built-in electric motor or a built-in motor (M), if required. In this case, the actuator of the first driving unit 50 can be omitted. Also, the wheel 62 of the first driving unit 50 may include a built-in motor (M). The scooter with variable wheel configuration described thus far will now be set forth in further detail with reference to its operation.

First, for a two-wheeled configuration of the scooter as shown in FIG. 3, a user or rider mounts a first driving unit 50 on the first mounting portion 42 of the mount 40. After the lower portion of the mount 40 is enclosed by the bent mounting portion 52a formed at the front of the base 52 of the first driving unit 50, the fastener 44 on the first mounting portion 42 is latched onto the notched portion 54. Then, the actuator 56 is connected to the wire connector 102 on the mount 40, and the brake assembly on the wheel 62 is connected to a brake wire connector 104 on the mount 40, which completes the configuring of the scooter.

In this configuration, a user selects the forward drive position on the control button 106, sits on the seat and grasps the handgrips 22 and 24, and operates the actuator 56 using the actuator control lever 32. Manipulation of the actuator control lever 32 causes the sprocket 58 to turn; and the turning force, or driving force, turns the sprocket 64 on the wheel 62 via a chain 66, causing the scooter to move forward. Of course, the rider can depress the brake lever 26 to stop or decelerate when needed. In order to reverse, the user can switch the control button 106 to the reverse rotating position, and follow the remainder of the steps described above.

This scooter, when intended for use by the puerile, elderly, and disabled or for safely carrying cargo, can be converted to a three-wheeled configuration, as shown in FIGS. 5 and 6.

For this purpose, the first driving unit 50 is removed from the first mounting portion 42 of the mount 40 at the rear end of the frame 10. More specifically, after unhooking the fasteners 44 on the first mounting portion 42 from the notched portion 54 of the first driving unit 50, the bent mounting portion 52a of the base 52 of the first driving unit 50 is removed from the first mounting portion 42. Next, using the handle 68, the user can carry the first driving unit 50 to the second mounting portion 46, to which it is to be mounted according to the previous description. After positioning the first driving unit 50 so that the bent mounting portion 52a at the front end of its base 52 encases the lower portion of the second mounting portion 46, the fastener 48 on the second mounting portion 46 is hooked onto the notched portion 54 of the base 52, completing the configuration.

In the next step, the user mounts the second driving unit 70 on the mount 40. That is to say, after positioning the second driving unit 70 so that the bent mounting portion 72a at the front end of its base 72 encases the lower portion of the second mounting portion 46 on the mount 40, a second coupling 84a at the open end of the drive shaft 84 connected to the transmission 82 is connected to the first coupling 60a at the open end of the drive shaft 60 of the first driving unit 50, thus connecting the first and second driving units 50 and 70 together. Then, the fastener 48 on the second mounting portion 46 is hooked onto the notched portion 74 of the base 72 of the second driving unit 70. Subsequently, the throttle wire connected to the actuator 76 is connected to the throttle wire connector 102 on the mount 40, and the brake assembly on the wheel 86 is connected to the brake wire connector 104 on the mount 40, thereby completing the installation of the second driving unit 70.

In this configuration, a rider sits on the seat 14, operates the actuator 76 of the second driving unit 70 using the actuator control lever 32, rotating the sprocket 78 of the actuator 76. The rotation of the sprocket 78 is relayed via a chain 80 to the transmission 82, which turns the drive shaft 84 connected to the transmission 82. By rotating, the drive shaft 84 turns the wheel 86 attached to its one end and the coupling 88 attached to its other end. In turn, the coupling 88 simultaneously rotates the wheel 62 of the first driving unit 50, which is attached to the open end of the first driving unit's axle 60, to which the coupling 88 is connected, thus driving the scooter.

Should the user want to revert the scooter to a two-wheeled configuration, a reversal of the previously described steps should be performed. The second driving unit 70 is removed from the mount 40 and the first driving unit 50, and then the first driving unit is moved to and installed on the first mounting portion 42 of the mount 40. The scooter can thus be reverted and used as a two-wheeler.

Accordingly, a rider or user can freely switch and use the scooter from a two to three-wheeled configuration and vice-versa, depending on her/his requirements.

The scooter described above with a two-wheeled configuration using the first driving unit 50 can easily be converted and used in a three-wheeled configuration, using the same first driving unit 50.

It will be apparent to those skilled in the art that various modifications and variations can be made in the present invention. Thus, it is intended that the present invention covers the modifications and variations of this invention provided they come within the scope of the appended claims and their equivalents.

### INDUSTRIAL APPLICABILITY

According to the scooter with variable wheel configuration of the present invention, a rider or user can select whether to configure and use the scooter as a two or three-wheeled vehicle, thereby increasing comfort and the number of applications for its use.

Furthermore, when switching between two and three-wheeled configurations, the wheels can be easily mounted and detached, improving workability.

Also, depending on the wheel configuration used, different configurations for driving units can be selected to improve effectiveness and efficiency.

What is claimed is:

1. A scooter with variable wheel configuration between a two-wheeled vehicle and a three-wheeled vehicle, the scooter comprising:
a frame for supporting and carrying a rider or a passenger and containing a battery and a controller;
a steering assembly mounted on the front of the frame to pivot in left and right directions for steering, the steering assembly having a lower portion to which a front wheel is rotatably mounted and an upper portion provided with a handgrip for a rider to steer, a brake lever, an actuator control lever, and a throttle grip;
a mount formed at a rear end of the frame in one-piece, the mount having a first mounting portion on one end and a second mounting portion on the other end;
a first driving unit detachably mounted on the first mounting portion of the mount for a two-wheeled configuration or on the second mounting portion of the mount for a three-wheeled configuration; and
a second driving unit detachably mounted to the first mounting portion and connected to the first driving unit for the three-wheeled configuration.

2. The scooter of claim 1, wherein each of the first and the second mounting portions includes a fastener for fastening the first driving unit and or the second driving unit.

3. The scooter of claim 2, wherein the fastener is a clamp and each of the first and the second driving units is provided with a notched portion for the clamp.

4. The scooter of claim 1, wherein the first driving unit includes:
a base capable of being detachably mounted to one of the first and second mounting portions of the mount;
an actuator installed at the base and being connected to the controller and the battery;
a drive shaft rotatably attached to the base, the drive shaft having a coupling on one end; and
a wheel rotatably connected to the other end of the drive shaft and the actuator.

5. The scooter of claim 4, wherein the base includes a bent mounting portion for detachably mounting the first driving unit on one of the first and second mounting portions.

6. The scooter of claim 4, wherein the actuator is a reversible motor capable of rotating in both forward and reverse directions.

7. The scooter of claim 4, wherein the actuator includes a first sprocket for power output and the wheel is provided at an inside with a second sprocket in one piece, the first and the second sprocket being connected by a chain.

8. The scooter of claim 1, wherein the first driving unit is provided with a handle.

9. The scooter of claim 1, wherein the second driving unit includes:
a base capable of being detachably mounted to the mount;
an actuator installed at the base;
a transmission connected with the actuator; and
a drive shaft connected to the transmission and rotatably attached to the base, the drive shaft having one end on which a wheel is mounted and the other end connected to the first driving unit.

10. The scooter of claim 9, wherein the base includes a bent mounting portion for inserting a lower part of the first mounting portion therein.

11. The scooter of claim 9, wherein the actuator is a fossil fuel-powered engine.

12. The scooter of claim 9, wherein the actuator includes a first sprocket for power output and the transmission includes a second sprocket, the first and the second sprocket being connected by a chain.

13. The scooter of claim 9, wherein the second driving unit is provided with a handle.

14. The scooter of claim 4, wherein the second driving unit includes a coupling on the other end of the drive shaft, the coupling of the second driving unit being detachably connected to the coupling of the second driving unit.

15. The scooter of claim 1, wherein the mount is provided with a throttle wire connector connected with the throttle grip via a wire, the throttle wire connector being selectively and detachably connected with actuators of the driving units.

16. The scooter of claim 1, wherein the mount is provided with a brake wire connector connected with the break lever via a wire and a brake assembly of each of the driving units.

17. The scooter of claim 1, wherein the first driving unit comprises an actuator built into a wheel.

18. The scooter of claim 1, wherein the front wheel includes a built-in actuator.

19. The scooter of claim 9, wherein the second driving unit includes a coupling on the other end of the drive shaft, the coupling of the second driving unit being detachably connected to the coupling of the second driving unit.
